(19) United States
(12) Patent Application Publication
(10) Pub. No.: US 2012/0104915 A1
(43) Pub. Date: May 3, 2012

(54) DISHWASHER

(75) Inventors: Johann Jobst, Regenstauf (DE); Franz Kiechle, Gunzburg (DE); Thomas Steck, Dillingen (DE)

(73) Assignee: BSH BOSCH UND SIEMENS HAUSGERATE GMBH, Munich (DE)

(21) Appl. No.: 13/286,251

(22) Filed: Nov. 1, 2011

(30) Foreign Application Priority Data
Nov. 3, 2010 (DE) 10 2010 043 269.5

(51) Int. Cl. A47L 15/50; F16C 29/10; F16C 29/04

(52) U.S. Cl. 312/228.1; 384/50

(57) ABSTRACT

A dishwasher includes a wash container, in which a rack for holding items to be washed and/or dried is disposed. At least two lateral guide rails are disposed in the wash container for supporting the rack and allowing the rack to be pulled out of the wash container. Each guide rail includes a guide element disposed in a guide path of the guide rail in a longitudinally movable manner. Provided on the guide rail is a stop which limits a longitudinal movement of the guide element along the guide rail. The stop projects in a first position into the guide path, thereby inhibiting a pull-out movement of the rack. When acted upon in opposition to a pull-out direction, the stop is shiftable out of the guide path into a second position and, when acted upon in the pull-out direction of the rack, the stop is fixed in the guide path.

### BACKGROUND OF THE INVENTION

The invention relates to a dishwasher, in particular a household dishwasher, having a wash container, in which at least one rack for holding items to be washed and/or dried is disposed, which can be pulled out of the wash container on at least two lateral guide rails, which are fitted with a guide element disposed in a longitudinally movable manner therein, whose capacity for longitudinal movement along the guide rail is limited by a stop provided on the guide rail which in a first position projects into the guide path of the guide rail, thereby inhibiting the pull-out movement of the rack.

Dishwashers, in particular household dishwashers, feature at least one rack for holding items being washed, said rack being supported in such a manner that it can be pulled out of a wash compartment of the household dishwasher for easier loading and unloading. The wash compartment of the household dishwasher can generally be closed off by a door. A number of embodiments of the displaceable holder for racks is known, in which rollers and guide rails interact in such a manner that it is possible to displace the rack (in a guided manner) out of the wash compartment and back into it again. In this process the rack is generally moved by means of rollers along the guide rail, with the result that a guide path is produced in the extension of the guide rail, along which the at least one roller passes during the displacement of the rack. The guide rail features at least one stop, which prevents the rack inadvertently sliding off or out of the guide rail or the rollers fastened to the rack sliding out of the guide path. This stop must be inserted to complete the assembly operation.

### BRIEF SUMMARY OF THE INVENTION

It is therefore an object of the invention to simplify the assembly of such a guide rail.

This object is achieved in that the stop, when it is struck counter to the pull-out direction out of the guide path, can be pushed into a second position and, when it is struck in the pull-out direction of the rack in the guide path, is fixed. The guide element can strike the stop in this process. This forms a directional blocking facility, which at a point on the guide path blocks displacement of the at least one guide element in the guide rail in the pull-out direction and allows it in the push-in direction, in which process by engaging a guide element of the directional blocking facility with the guide rail by means of an assembly movement along the guide path in the push-in direction, the stop can be moved from a first position into a second position, the stop in the first position releasing the guide path in the push-in and pull-out directions and in the second position blocking the guide path in the push-in direction. It can therefore be brought about by an assembly movement for introducing a roller in the push-in direction, e.g. a pivot movement from the first to the second position of the stop. Therefore when the roller is introduced into the guide path in the push-in direction for example, the pivot movement can take place. This allows simple assembly by means of a joint movement in the push-in direction, e.g. to produce an engagement between the guide rail and the guide element, e.g., rollers, while disassembly by means of a movement in the pull-out direction is prevented after this joint movement. It is therefore not necessary for a fitter to remove or unclamp or unlatch the stop.

In one preferred embodiment provision is made for the stop to be supported movably on the guide rail between the first position and the second position, with the stop releasing the guide path in the second position and blocking the guide path in the first position. In contrast to the prior art the stop is supported on the guide rail in such a manner that it can be moved between a first position and a second position. In the second position the stop releases the guide path, while in the first position it blocks it.

The stop can be part of the guide rail, i.e. stop and guide rail are configured as a single piece, e.g. made of plastic, it being possible for provision to be made for material weakening at the connecting point between stop and guide rail, in order to support the stop movably or pretension it elastically. In a further, preferred embodiment however provision is made for the stop to be assigned to an end clamp fastened to the guide rail. This allows the end clamp with the stop and the guide rail to be made from different materials and then be connected together.

In one preferred embodiment provision is made for the stop to be assigned a hooked limb to allow a pivot movement. The guide rail can feature the hooked limb here. Provision is made in a further embodiment for the hooked limb to be assigned to the end clamp.

The hooked limb can preferably be formed by means of a cutout introduced into a base body of the end clamp and running around the hooked limb essentially in a U-shape.

In one advantageous embodiment the stop is supported pivotably; in other words it can be moved out of the first position into the second position and vice versa by a pivot movement. The stop therefore assumes the first position or second position by means of a pivot movement of said stop or a part of said stop. It is in particular not necessary here to remove the stop as a whole from its position on the guide rail or even only essentially move it out of this. The release of the guide path in the first position and the closing/blocking of the guide path in the second position take place by means of the cited pivot movement of the stop, which per se, at least essentially, remains in its assembly position on the guide rail.

Provision is advantageously made for the stop to have a run-in slope that can be brought into contact with the guide element. Such a, for example wedge-shaped, run-in slope on the stop can facilitate the introduction of the guide element during the simultaneous displacement of the stop from the first position into the second position. A run-in slope is formed here by a for example wedge-shaped configuration, so that when the for example roller-shaped engagement element meets the run-in slope of the stop, the stop is forced to pivot so that the guide element can be moved past the deflected stop along the guide path of the guide rail into an assembly position.

This makes it easy to assemble guide elements of the rack, e.g. rollers in the roller guide of the guide rail, as the rollers are pushed in quite a simple manner into the guide path of the guide rail. Instead of rollers the rack can also have drums or spigots with a friction-reducing coating. The pushing in action produces the pivot movement of the stop, which release the guide path, thereby allowing the passage of the e.g. roller into the roller guide in the guide path. In contrast in the counter, first direction the stop blocks the movement of the roller, with the result that the roller can no longer slide out of the roller guide and therefore cannot leave the guide path. If the roller is disposed on the rack for example, the rack can be displaced by means of the roller along the guide path in the roller guide of the guide rail, in other words in particular it can be pulled out of the wash compartment of the household dishwasher, the roller being preventing from sliding out of the guide path of the guide rail by the stop, since the rack is pulled out in the first direction blocked by the stop. If in contrast, for whatever reason, the rack is deliberately removed from the household dishwasher and the roller is therefore deliberately detached from the guide path of the guide rail, it can easily be put back into the roller guide of the guide rail by simple introduction in the second direction, i.e. into the guide path, with the result that the rack again assumes its working position on the guide rail.

In one preferred embodiment the stop is held in an elastically pretensioned manner in the first position. This very advantageously ensures that the stop is held in the first position, in which the guide path is blocked, as long as a force that would move it is not acting on it. The rest state in the final assembly position of the stop is therefore the position, specifically the first position, which blocks the guide path.

In a further preferred embodiment a securing means is provided, which secures the stop in the first position. The securing means here serves to secure the first position, which blocks the guide path, in such a manner that a movement of the stop from the first position into the second position for example cannot take place inadvertently, thereby releasing the guide path. This prevents inadvertent release of the guide path.

Provision is preferably made for the securing means to feature at least one engagement means, which can be made to engage with a fastening segment by displacing the stop from a first into a second movement position. The securing means, which ensures the securing of the stop in the first position, therefore features at least one engagement means, which engages with the fastening segment. It is thus possible to move the engagement means into a first and second movement position by displacing the stop.

In a further embodiment the stop can be displaced by moving it along an axis. The stop itself can therefore not only be pivoted (at least in segments or parts) but can also be displaced, said displacement taking place along an axis. In addition to the first and second positions, as described above, the stop can therefore also assume different positions along the axis in the axial extension.

Provision is preferably made for the axis to extend along the guide rail. The axis, along which the stop can be displaced, therefore extends along the guide rail, in particular along the longitudinal extension of the guide rail. Provision is particularly preferably made for the axial displacement of the stop to take place parallel to the longitudinal extension of the guide rail.

The object is also achieved by a guide rail having such a stop for a dishwasher.

### BRIEF DESCRIPTION OF THE DRAWINGS

The invention is described in more detail below with reference to exemplary embodiments, without being limited thereto. In the drawings:

FIG. 1 shows a guide rail with two rollers and stop;

FIG. 2 shows a sectional diagram through an end region of the guide rail;

FIG. 3 shows such a sectional diagram with roller assembled;

FIG. 4 shows a diagram of the stop on the guide rail and

FIG. 5 shows a diagram of the stop on the guide rail from the web outer face.

### DETAILED DESCRIPTION OF EXEMPLARY EMBODIMENTS OF THE PRESENT INVENTION

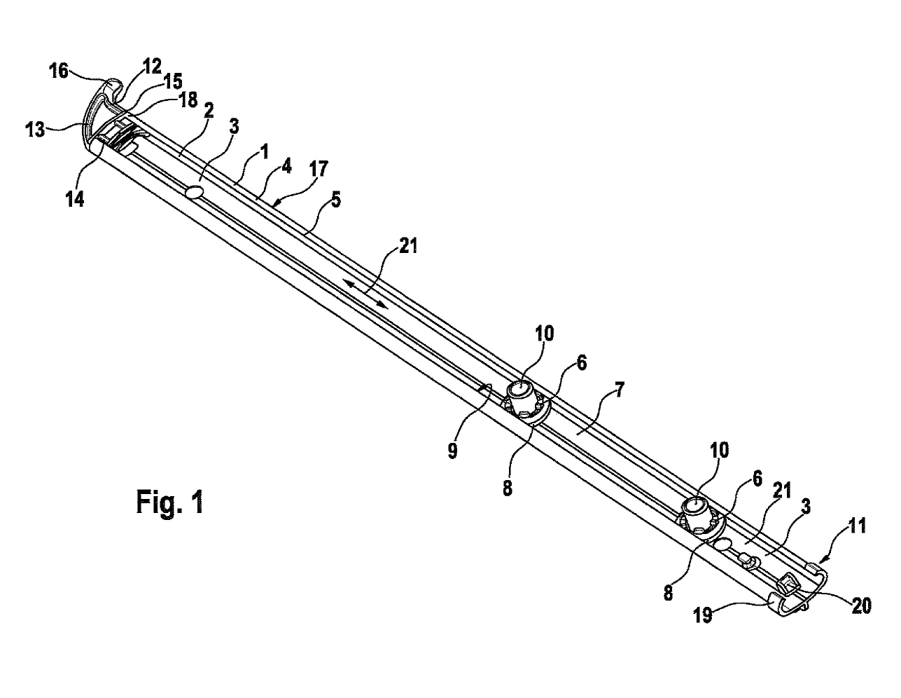

FIG. 1 shows an exemplary embodiment of a guide rail 1 to hold a rack (not shown) with roller support in a household dishwasher (not shown). The guide rail 1 is configured essentially as a C-profile 2, when viewed in cross section, having a web 3 and arms 4 with overreaching limbs 5 above and below said web 3. The arms 4 disposed on the web 3 and the overreaching limbs 5 that at least partially close off the C-profile 2 again in respect of its clear width opposite the web 3 in the present exemplary embodiment hold guide elements disposed therein, in the present exemplary embodiment guided rollers 6, preventing them from tipping out of the roller guide 7 configured in the interior of the C-profile 2 along the guide rail 1. The two rollers 6 shown are therefore held within the C-profile 2 in the roller guide 7 in such a manner that they can be displaced over its longitudinal extension. On their outer periphery the rollers 6 have running surfaces 8, which are supported on the inner faces 9 of the arms 4 and roll in the roller guide 7. The rollers 6 are fastened with a concentric roller holder 10 (preferably in an axis of rotation of the rollers 6) to an inner wall (not shown) of the wash compartment (not shown) of the household dishwasher (not shown), with the result that the guide rail 1 slides on the rollers 6 and can be pulled out of and pushed back into the wash compartment (not shown).

On a guide rail end 18 facing a door (not shown) for closing off the wash compartment and/or a wash compartment opening (not shown) of the household dishwasher, the guide rail 1 has an essentially hook-shaped guide rail termination 12, which is configured as a plastic part 13 and is introduced into an open cross section 14 on an end face 15 of the guide rail 1 and held there, preferably by suitable means, for example latches. These means for fixing the guide rail termination 12 prevent the guide rail termination 12 becoming inadvertently detached from the guide rail 1, when subjected to a force, for example when struck by a rack (not shown). The guide rail termination features a terminating lug 16, which prevents rack rollers assigned to the rack and guided along an upper arm face 17 of the guide rail 1 (not shown) from sliding down off the guide rail 1 or off the upper arm face 17.

Positioned on the web and arms in the correspondingly opposite position 11, projecting into the household dishwasher (not shown), in the present exemplary embodiment an end position 11 of the guide rail 1 at one of its ends, and overreaching the outside of the C-profile 2 of the guide rail 1 at its ends but leaving the open cross section 14 open, is an end clamp 19. The end clamp 19 features a stop 20, which projects into a guide path 21 configured in the longitudinal extension of the roller guide 7. This projection into the guide path 21 means that the two rollers 6 guided in the roller guide 7 are prevented from sliding out of said roller guide 7 in the region of the end face 11 (specifically the open cross section 14). The stop 20 projects into the guide path 21 in such a manner that the open cross section 14 is reduced, in some regions at least, specifically so that the running surface 8 of a roller 6 is forced into contact with the stop 20, as soon as it tries to leave the roller guide 7 through the open cross section 14 in the region of said stop 20. This reduction of the cross section 14 in such a manner that it is too small to allow the passage of the roller 6 means that the roller 6 is held in the roller guide 7.

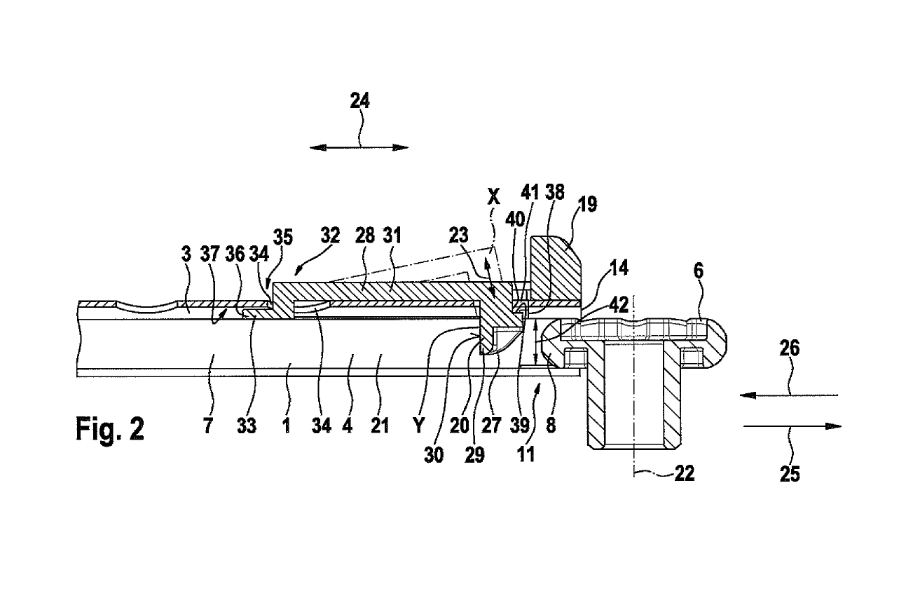

FIG. 2 shows a sectional diagram through the guide rail 1 roughly in the center of the web 3 looking down onto an arm 4 of the guide rail 1. Shown in cross section are the stop 20 and a roller 6, the latter in its roller axis 22.

The stop 20 is supported on the guide rail 1 in such a manner that it can assume a first position X and a second position Y. In the second position Y the stop 20 releases the guide path 21 for the passage of the roller 6, while in the first position X the stop 20 blocks the guide path 21 and therefore the passage of the roller 6. The stop 20 can be moved from the first position X to the second position Y and vice versa by a pivot movement 23.

The roller 6 can move in the guide path 21 in the longitudinal direction 24 of the guide rail 1, specifically in a first direction 25 and in a second direction 26, the first direction 25 being counter to the second direction 26. In this process the stop 20 allows the passage of the roller 6 through the open cross section 14 on the end face 11 of the guide rail 1 in the direction of the second direction 26 into the guide path 21, running on the arm 4 of the guide rail 1. The stop 20 is moved here by the running surface 8 of the roller 6 from its second position Y, in which it blocks the guide path, into the first position X, specifically by the pivot movement 23. The pivot movement 23 can therefore be brought about by introducing the roller 6 in the direction of the second direction 26. To this end the stop 20 has an oblique run-on surface 27 facing the end face 11 of the guide rail 1, which, on contact with the running surface 8 of the roller 6 in the direction of the second direction 26, by vector force breakdown, causes the stop 20 to be pushed out of its second position Y to pivot into the first position X.

The stop 20 is configured as a plastic molded part 28, said stop 20 essentially being configured in some regions in a hook shape so that a stop head 29, featuring the run-on surface 27 on the one hand facing the end face 11 and an impact surface 30 on the other hand facing away from the end face 11 of the guide rail 1, is connected to an essentially tongue-shaped hooked limb 31, the hooked limb 31 being cut out of the plastic molded part 28 configured as the end clamp 19 in the region of the stop head 29 and along the hooked limb 31, so that it is only connected to the plastic molded part 28 (end clamp 19) at the hooked limb end 32 away from the stop head 29. This brings about elastic pretensioning of the stop 20 in the first position X. The pivot movement 23, i.e. the deflection of the stop 20 from the first position X into the second position Y, therefore takes place during the introduction of the roller 6 into the guide path 21 counter to this elastic pretension. The elastic pretension here can be brought about in particular by the material of the plastic molded part 28, which for this purpose is configured with a certain degree of inherent elasticity. The pivot movement 23 can therefore be brought about by elastic deformation of the plastic molded part 28, with no plastic deformation occurring but the stop 20 returning, as soon as the stop 20 is no longer subjected to force by the roller 6 in the region of the stop head 29.

The plastic molded part 28 features a bearing segment 33, which engages in a bearing opening 34 of the web 3 from a web outer face 35 and fixes the plastic molded part 28 with its end 36 away from the stop head 29. The hooked limb 31 is therefore disposed on the web outer face 35, while the bearing segment 33 is supported on a web inner face 37 after passing through the bearing opening 34. This advantageously fixes the stop 20, specifically the entire plastic molded part 28 configured as the end clamp 19, in the intended assembly position so that it is disposed securely on the guide rail 1.

Provided on the stop 20 in the region of the stop head 29 is a securing means 38, which prevents movement of the stop head 29 from the first position X into the second position Y. To this end the stop head is provided with a bottom holding surface 39 running essentially parallel to the web 3 in the second position Y, this being configured for example as an indentation 40 in the hook angle 31 in the region of the stop head 29, facing the web 3. To execute the pivot movement 23 at least some regions of the stop 20 with the stop head 29 pass through a web recess 41, in order to create sufficient clear width 42 in the roller guide 7 for the passage of the roller 6. During the performance of this pivot movement 23 initiated by the passage of the roller 6 the holding surface 39 lies opposite the web recess 41, so that the pivot movement 23 can take place. However if the roller 6 has already been introduced in a position not shown here into the guide path 21 of the roller guide 7, in other words in such a manner that the running surface 8 lies opposite the impact surface 30 of the stop 20, not the run-on surface 27, the application of force to the impact surface 30 causes the stop head 29 to be pushed in the first direction 25 in such a manner, specifically along the longitudinal direction 24, that the holding surface 39 lies opposite the web inner face 37. This prevents the performance of the pivot movement 23, since the holding surface 39 is no longer exactly opposite the web recess 41 but is opposite the web inner face 37, and subject to the action of this.

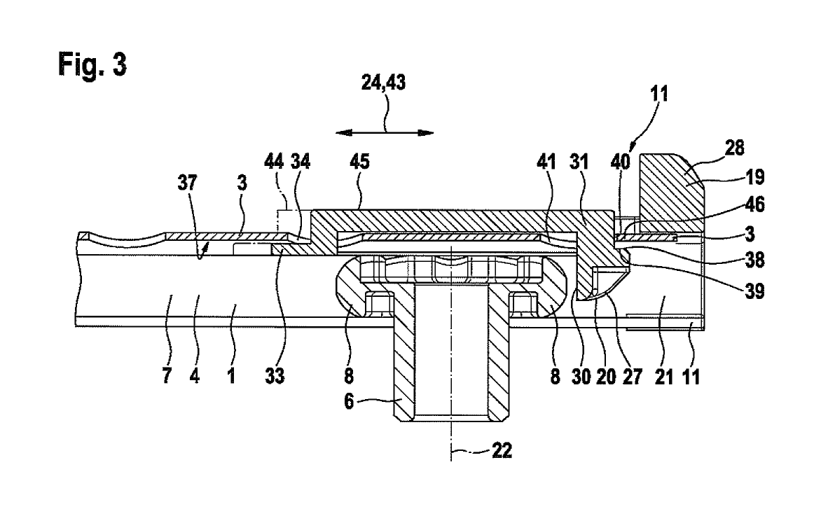

FIG. 3 shows the end face 11 of the guide rail 1 with the stop 20 and the roller 6, again in a sectional diagram at the level of the roller axis 22. The stop 20 is in the form of a plastic molded part 28, specifically all as a single piece with the end clamp 19, and can be displaced along an axis 43 from a first movement position 44 into a second movement position 45, specifically being moveable in the longitudinal direction 24 of the guide rail 1.

The roller 6 here rests with its running surface 8 again on the arm 4 of the guide rail 1 within the roller guide 7. The plastic molded part 28 configured as the end clamp 19, which forms the stop 20, is supported, as set out above, on the end face of the guide rail 1 in such a manner that it can be moved longitudinally along the axis 43 in the longitudinal direction 24 of the guide rail 1.

The securing means 38 which, as described in relation to FIG. 2, is configured for example as an indentation 40 on the face of the stop head 29 facing the end face 11, is made to engage here with a fastening segment 46 of the web 3 of the guide rail 1, the fastening segment 46 being assigned to the web recess 41; the web recess 41 here has such an opening width that in the first movement position 44 the stop head 29 can pass through, with the securing means 38, in particular the holding surface 39, not engaging with the fastening segment 46, so that the pivot movement 23 (see also FIG. 2) can take place. In the second movement position 45 shown here the securing means 38 is engaged with the fastening segment 46, so that the pivot movement 23 (as shown in FIG. 2) cannot take place.

When the running surface 8 of the roller 6 strikes the impact surface 30, the force applied to the impact surface 30, mediated by way of the hooked limb 31, displaces the entire plastic molded part 28 in a longitudinal direction 24, so that it assumes the illustrated second movement position and so the securing means 38 necessarily engages with the fastening segment 46. Inadvertent release of the guide path 21, which would allow the roller 6 to slide out of the roller guide 7, is hereby reliably prevented. Conversely when the roller 6 is introduced, from the end face 11 into the roller guide 7 along the guide path 21, the run-on surface 27 of the stop head 29 is struck by the roller 6, so that the pivot movement 23 shown in FIG. 2 is brought about when the first position X, also shown in FIG. 2, is assumed, with the entire plastic molded part 28 on the end face 11 of the guide rail 1 being displaced from the second movement position 45 shown here into the first movement position 44 due to the roller 6 striking the run-on surface 27. The bearing segment 33 of the stop 20 here is displaced in the bearing opening 34 in the same manner, to which end the bearing opening 34 has a width of sufficiently large dimensions to allow this longitudinal displacement. The bearing segment 33 is configured in its longitudinal extension (along the guide rail 1) on the web inner face 37 in such a manner that even with displacement in a longitudinal direction 24 it does not allow the indentation of the web 3 through the bearing opening 34, so that the stop 20 is always held on the web inner face by the bearing segment 33, regardless of whether it is in the first movement position 44, the second movement position 45 or an intermediate position.

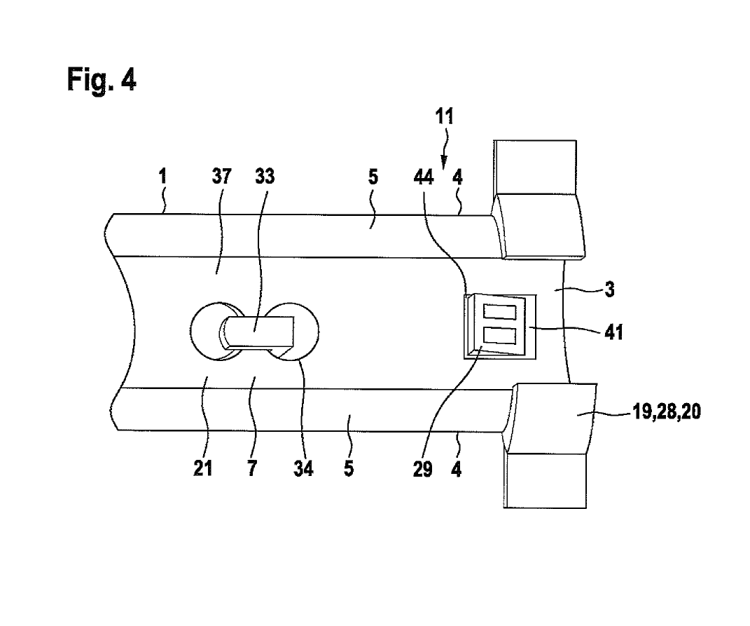

FIG. 4 shows the end face 11 of the guide rail 1 looking down onto the web inner face 37 with the end clamp 19 pushed onto the arms 4, web 3 and overreaching limbs 5 and as a plastic molded part 28 forming the stop 20. The stop head 29 passes, in the first movement position 44 shown here and releasing the guide path 21 of the roller guide 7 and thus allowing the pivot movement 23, through the web recess 41, the bearing segment 33 passing through the bearing opening 34 of the web 3 and being held on the web inner face 37.

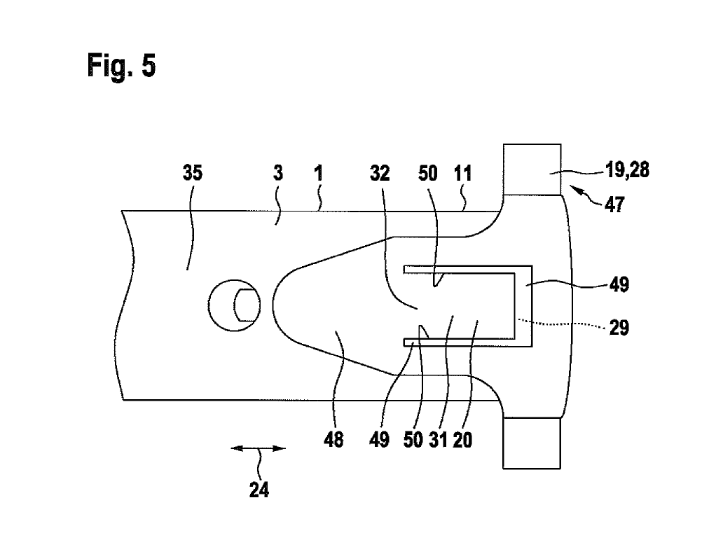

FIG. 5 shows the arrangement of the web outer face 35 of the web 3, as shown in FIG. 4, specifically the configuration of the stop 20 as a plastic molded part 28 in the form of an end clamp 19, which is pushed in its entirety onto the end face 11 of the running rail 1. The end face 11 is held at its termination 47 by a clamp fitting of the end clamp 19 that exercises a clamping effect, so that the end clamp is held on the end face 11 of the running rail 1 by the clamping action. Configured as a single piece herewith is a bearing tongue 48, which is oriented away from the end face 11 in the longitudinal direction 24 of the running rail 1 and features the hooked limb 31, which is configured by a cutout 49 from the material of the plastic molded part 28, in such a manner that it is cut out on its hooked limb longitudinal faces 50 and the end face 11 facing the guide rail but not on the hooked limb end 32. This allows elastic pivoting of the stop head 29 disposed on the opposite face (not shown here) of the hooked limb 31 due to the material properties of the plastic molded part 28. The entire plastic molded part 28 forming the end clamp 19, which is held automatically by its clamping action when pushed onto the end face 11 of the guide rail 1, as a single-piece component here brings about the securing of introduced rollers 6 (not shown here in FIG. 5) in a very simple manner and simple assembly of the same. The securing and release for assembly of the guide path 21 illustrated in FIGS. 1 to 4 take place automatically here. The stop 20 thus configured is disposed securely on the guide rail 1 and can be produced economically as a plastic molded part.

What is claimed is:

1. A dishwasher, comprising:
a wash container, in which at least one rack for holding items to be washed and/or dried is disposed;
at least two lateral guide rails disposed in the wash container for supporting the rack and allowing the rack to be pulled out of the wash container, each said guide rail including a guide element disposed in a guide path of the guide rail in a longitudinally movable manner; and
a stop provided on the guide rail to limit a longitudinal movement of the guide element along the guide rail and projecting in a first position into the guide path of the guide rail, thereby inhibiting a pull-out movement of the rack, said stop, when acted upon in opposition to a pull-out direction out of the guide path, being shiftable into a second position and, when acted upon in the pull-out direction of the rack, is fixed in the guide path.

2. The dishwasher of claim 1, constructed in the form of a household dishwasher.

3. The dishwasher of claim 1, wherein the stop is supported on the guide rail for movement between the first position and the second position.

4. The dishwasher of claim 1, wherein the stop is assigned to an end clamp which is fastened to the guide rail.

5. The dishwasher of claim 1, wherein the stop is assigned to a hooked limb to allow pivot movement.

6. The dishwasher of claim 5, wherein the stop is assigned to an end clamp which is fastened to the guide rail, said hooked limb being assigned to the end clamp.

7. The dishwasher of claim 5, wherein the hooked limb is formed by a cutout.

8. The dishwasher of claim 1, wherein the stop is supported in a pivotable manner.

9. The dishwasher of claim 1, wherein the stop includes a run-in slope that can be brought into contact with the guide element.

10. The dishwasher of claim 1, wherein the stop is held in an elastically pretensioned manner in the first position.

11. The dishwasher of claim 1, further comprising a securing member, which secures the stop in the first position.

12. The dishwasher of claim 11, wherein the securing member prevents movement of the stop from the first position into the second position.

13. The dishwasher of claim 11, wherein the securing member includes at least one engagement member for engagement with a fastening segment of the guide rail by displacing the stop from a first movement position into a second movement position.

14. The dishwasher of claim 1, wherein the stop is displaced by moving it along an axis, which extends along the guide rail.

15. A guide rail assembly for a dishwasher, comprising:
a guide rail disposed in a wash container of the dishwasher for support of a rack holding items to be washed and/or dried and allowing the rack to be pulled out of the wash container, said guide rail including a guide element disposed in a guide path of the guide rail in a longitudinally movable manner; and
at least one stop provided on the guide rail to limit a longitudinal movement of the guide element along the guide rail and projecting in a first position into the guide path of the guide rail, thereby inhibiting a pull-out movement of the rack, said stop, when acted upon in opposition to a pull-out direction out of the guide path, being shiftable into a second position and, when acted upon in the pull-out direction of the rack, is fixed in the guide path.

16. The guide rail assembly of claim 15, wherein the stop is supported on the guide rail for movement between the first position and the second position.

17. The guide rail assembly of claim 15, wherein the stop is assigned to an end clamp which is fastened to the guide rail.

18. The guide rail assembly of claim 15, wherein the stop is assigned to a hooked limb to allow pivot movement.

19. The guide rail assembly of claim 18, wherein the stop is assigned to an end clamp which is fastened to the guide rail, said hooked limb being assigned to the end clamp.

20. The guide rail assembly of claim 18, wherein the hooked limb is formed by a cutout.

21. The guide rail assembly of claim 15, wherein the stop is supported in a pivotable manner.

22. The guide rail assembly of claim 15, wherein the stop includes a run-in slope that can be brought into contact with the guide element.

23. The guide rail assembly of claim 15, wherein the stop is held in an elastically pretensioned manner in the first position.

24. The guide rail assembly of claim 15, further comprising a securing member, which secures the stop in the first position.

25. The guide rail assembly of claim 24, wherein the securing member prevents movement of the stop from the first position into the second position.

26. The guide rail assembly of claim 24, wherein the securing member includes at least one engagement member for engagement with a fastening segment of the guide rail by displacing the stop from a first movement position into a second movement position.

27. The guide rail assembly of claim 15, wherein the stop is displaced by moving it along an axis, which extends along the guide rail.
